(19) United States
(12) Patent Application Publication
(10) Pub. No.: US 2004/0243603 A1
(43) Pub. Date: Dec. 2, 2004

(54) Configuration setting apparatus, configuration setting method, and configuration setting program product

(75) Inventor: Masaki Komatsu, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/856,719

(22) Filed: May 28, 2004

(30) Foreign Application Priority Data
May 28, 2003 (JP) 2003-150057

(51) Int. Cl. G06F 17/00

(52) U.S. Cl. 707/100

(57) ABSTRACT

The configuration setting apparatus comprises: a database which holds, for each device of different types, configuration information setting formats needed to set configurations of devices on the basis of configuration information; an http server which transmits a common electronic document among the devices of different types, the electronic document being inputted with type identification information to identify types of the devices and the configuration information needed to set configurations of the devices, and which receives, in a common format among the devices of different types, the type identification information and configuration information inputted into the electronic document; a search section which searches, from the database, a configuration information setting format that corresponds to the device type identified by the type identification information; an application section which applies the searched configuration information setting format to the received configuration information; and a device interface section which transmits, to a device, the configuration information that the configuration information setting format has been applied to.

### BACKGROUND OF THE INVENTION

1. Field of the Invention

The present invention relates to a configuration setting apparatus and a configuration setting method for setting configurations of devices, and more particularly, to a configuration setting apparatus and a configuration setting method for setting configurations of network devices via a network.

2. Related Background Art

Configuration information, which is externally provided, is required to set configuration (formation or status) of a network device. This configuration information must be supplied to a network device according to a predetermined configuration information setting format in order to set configuration of the network device on the basis of the configuration information. However, configuration information setting formats differ from manufacturer to manufacturer, or type to type of the network devices.

Thus, as shown in FIG. 1, in order to set a configuration of a router 23-1 through a terminal 22-1, for example, it is necessary to apply the configuration information setting format that meets the router 23-1 to the configuration information and transmit it from the terminal 22-1 to the router 23-1. To set a configuration of a router 23-2 through the terminal 22-1, it is necessary to apply the configuration information setting format that meets the router 23-2 to the configuration information and transmit it from the terminal 22-1 to the router 23-2. Likewise, to set a configuration of a router 23-3 through the terminal 22-1, it is necessary to apply the configuration information setting format that meets the router 23-3 to the configuration information and transmit it from the terminal 22-1 to the router 23-3.

As a method of transmitting such configuration information of each network device, a method of centrally controlling the configuration information of each network device by a configuration management server is available (for example, Japanese Patent Application Laid-Open Publication No. 08-202657 (pages 4 to 6, FIG. 1)).

Further, as a method of performing an installation to uniquely set up each of the computers that constitute a computer system, there is a method in which an install server acquires an installation parameter corresponding to the target device from a unique information database, creates configuration file that holds a configuration of install software in accordance with the parameter, and transmits the configuration file to the target device (for example, Japanese Patent Application Laid-Open Publication No. 09-218777 (pages 4 to 6, FIG. 1)).

In the above conventional configuration setting method for network devices, configurations are needed for each router of different manufacturers, so that different interfaces are required in the system. Further, it takes a skill for personnel operating and maintaining the system.

Further, in the conventional configuration setting method for network devices, it is impossible to centrally manage configurations of each router that are provided by different manufacturers. Thus, when a router from one manufacturer is replaced by a router from the other manufacturer, desired configuration cannot be obtained, which can results in troubles such as a network failure. Even with techniques disclosed in the above two patent documents, the disadvantages described above cannot be solved.

### SUMMARY OF THE INVENTION

An object of the present invention is to solve the above-described disadvantages and provide a configuration setting apparatus, a configuration setting method, and a configuration setting program which can set configurations of devices without requiring a skill for uniquely setting the configurations of each device.

According to the present invention, there is provided a configuration setting apparatus characterized by comprising: a database which holds, for each device of different types, configuration information setting formats needed to set configurations of the devices on the basis of configuration information; a first transmission means for transmitting a common electronic document among the devices of different types, the electronic document being inputted with type identification information to identify types of the devices and the configuration information needed to set configurations of the devices; a reception means for receiving, in a common format among the devices of different types, the type identification information and configuration information inputted into the electronic document; a search means for searching, from the database, a configuration information setting format that corresponds to the device type identified by the type identification information; an application means for applying the searched configuration information setting format to the received configuration information; and a second transmission means for transmitting, to a device, the configuration information that the configuration information setting format has been applied to.

In the above configuration setting apparatus, the electronic document is inputted with an IP address of a device in addition to the type identification information and configuration information. It follows that the reception means may receive the IP address inputted into the electronic document in addition to the type identification information and configuration information, and that the second transmission means may transmit the configuration information to the device with the IP address being as a destination.

### BRIEF DESCRIPTION OF THE DRAWINGS

FIG. 1 is a view for explaining a configuration setting method according to the conventional example;

FIG. 2 is a conceptual view for explaining a configuration setting method according to an embodiment of the present invention;

FIG. 3 is another conceptual view for explaining the configuration setting method according to the embodiment of the present invention;

FIG. 4 is a block diagram showing the structure of a configuration setting apparatus according to the embodiment of the present invention;

FIG. 5 is a flowchart showing the configuration setting method according to the embodiment of the present invention;

FIG. 6 is a view showing the display screen of the HTML electronic document for input according to the embodiment of the present invention;

FIG. 7 is a view showing an example of the configuration information that the configuration information setting format has been applied to according to the embodiment of the present invention; and

FIG. 8 is a view showing another example of the configuration information that the configuration information setting format has been applied to according to the embodiment of the present invention.

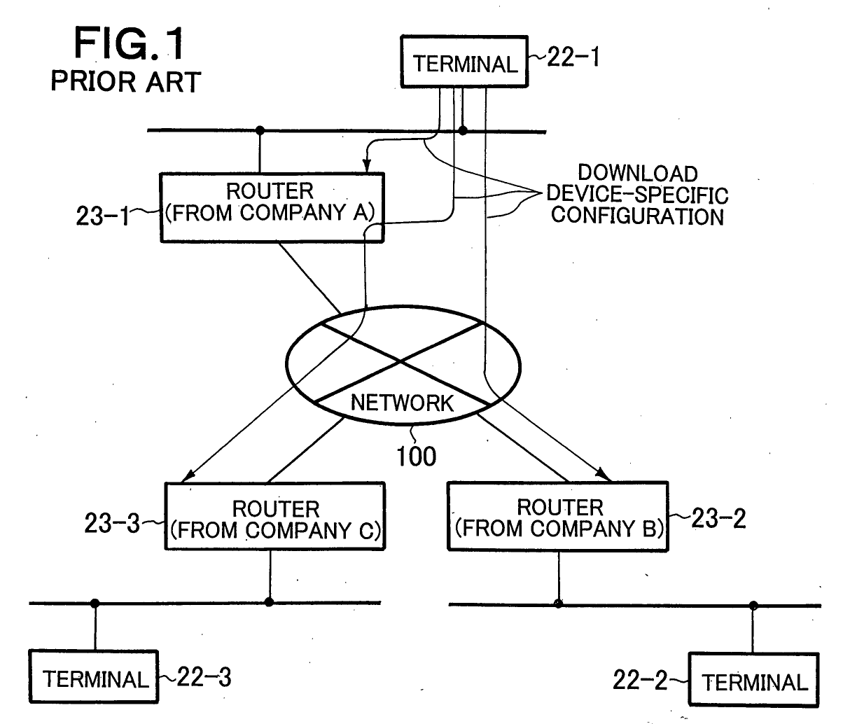

### DESCRIPTION OF THE PREFERRED EMBODIMENTS

An embodiment of the present invention will be described in detail below with reference to the accompanying drawings.

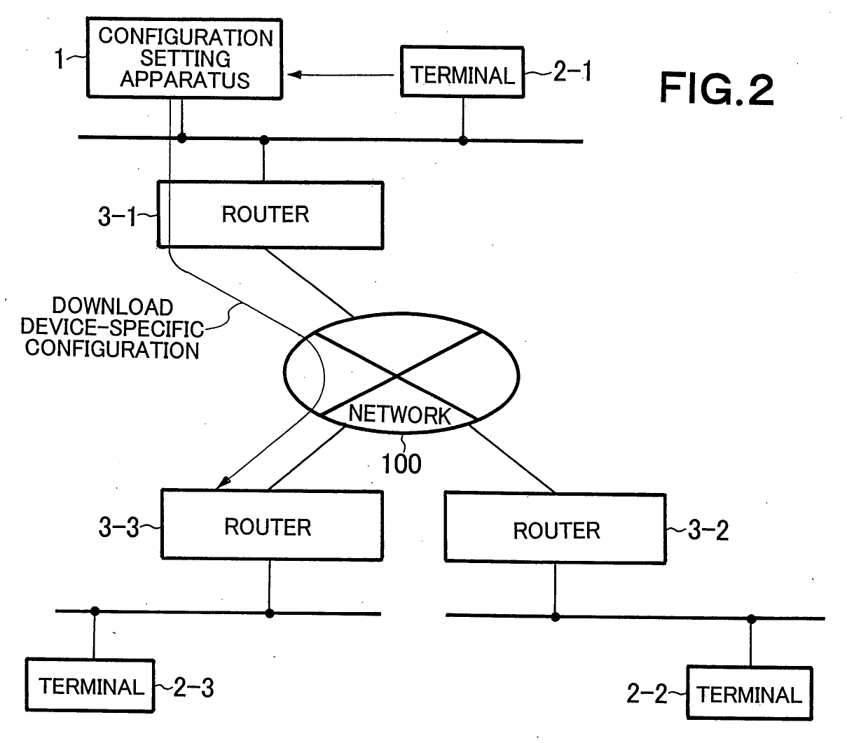

Referring to FIG. 2, a configuration setting apparatus is connected to a terminal 2-1 and a router 3-1 via a local IP (Internet Protocol) network. A terminal 2-2 is connected to a router 3-2 via another local IP network. A terminal 2-3 is connected to a router 3-3 via still another local IP network. The routers 3-1, 3-2 and 3-3 are connected to each other via the Internet, which is a global IP network.

FIG. 2 shows a state where the configuration information inputted into the terminal 2-1 is transmitted to the router 3-3 via the configuration setting apparatus 1 to set the configuration of the router 3-3.

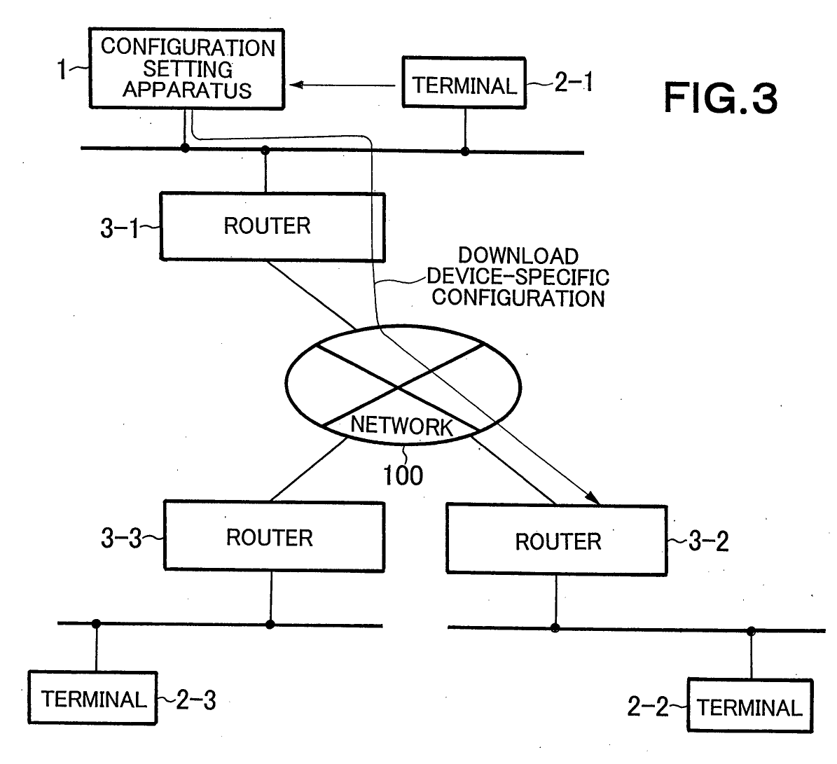

FIG. 3 shows a state where the configuration information inputted into the terminal 2-1 is transmitted to the router 3-2 via the configuration setting apparatus 1 to set the configuration of the router 3-2.

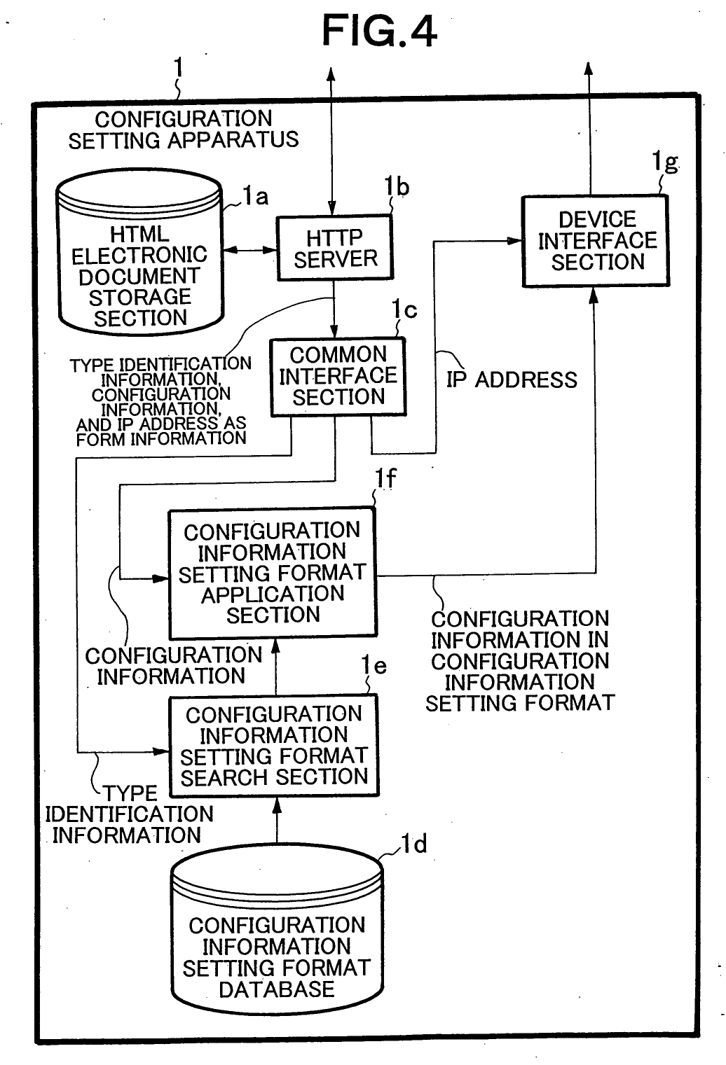

Referring to FIG. 4, the configuration setting apparatus 1 comprises an HTML (Hyper-Text Markup Language) electronic document storage section 1a, an http (Hyper-Text transfer Protocol) server 1b, a common interface section 1c, a configuration information setting format database 1d, a configuration information setting format search section 1e, a configuration information setting format application section 1f, and a device interface section 1g.

The HTML electronic document storage section 1a stores various types of HTML electronic documents, and particularly, stores the HTML electronic documents that configuration information and the like are inputted into.

The http server 1b reads out the HTML electronic document requested by an http client from the HTML electronic document storage section 1a so as to transmit it to the http client. The http server 1b also receives form information transmitted from the http client so as to supply the common interface section 1c with the form information.

The common interface section 1c extracts type identification information, configuration information, and IP address which are included in the form information. Here, the type identification information is used to identify the manufacturer and the type of each router. The IP address indicates the IP address of each router. The common interface section 1c supplies: the configuration information setting format search section 1e with the type identification information; the configuration information setting format application section 1f with the configuration information; and the device interface section 1g with the IP address.

The configuration information setting format database 1d holds, for each device of different manufacturers/types, the configuration information setting formats needed to set configurations of each device on the basis of the configuration information.

The configuration information setting format search section 1e searches, from the configuration information setting format database 1d, the configuration information setting format corresponding to the type identification information received from the common interface section 1c, and supplies the configuration information setting format application section 1f with the searched configuration information setting format.

The configuration information setting format application section 1f applies the configuration information setting format received from the configuration information setting format search section 1e to the configuration information received from the common interface section 1c, and supplies the device interface section 1g with the configuration information that the configuration information setting format has been applied to.

The device interface section 1g transmits, using a protocol such as ftp (file transfer protocol), tftp (trivial file transfer protocol) or the like, the configuration information received from the configuration information setting format application section 1f and the configuration information setting format has been applied to, to the router having an IP address received from the common interface section 1c.

The http (Hyper-Text transfer Protocol) server 1b, common interface section 1c, configuration information setting format search section 1e, configuration information setting format application section 1f, and device interface section 1g can be realized by loading a program into a computer from a recording medium, the program allowing the computer to function as a part of the above sections, and by executing the program through the computer.

Next, a configuration setting method according to the present embodiment will be described.

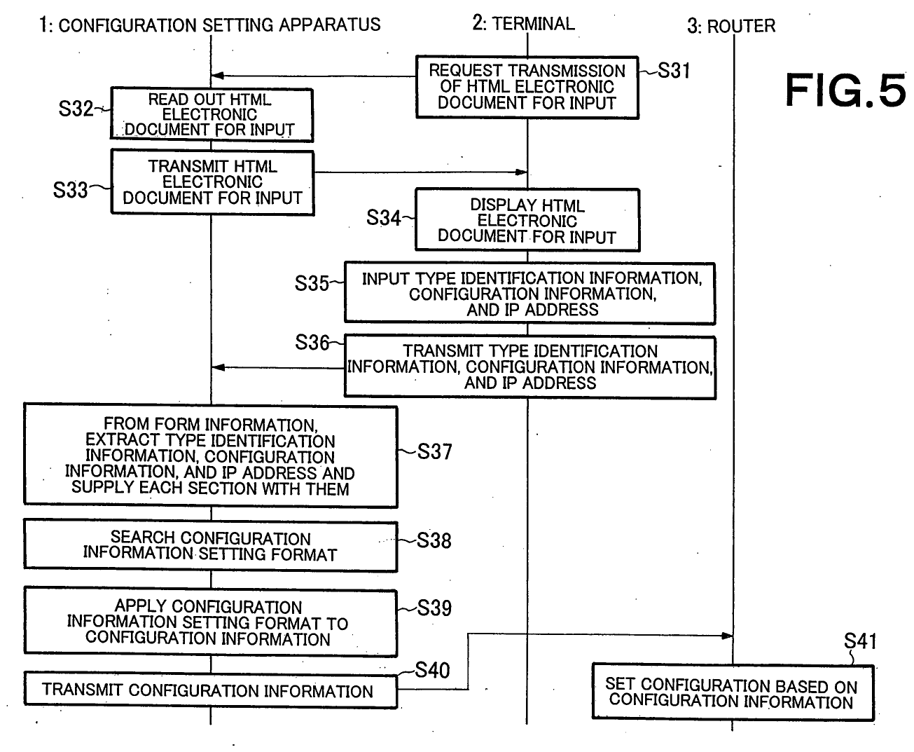

Referring to FIG. 5, the terminal 2 equipped with an http client transmits, to the configuration setting apparatus 1, a request for transmission of an HTML electronic document for input (step S31).

Next, the http server 1b reads out the HTML electronic document for input from the HTML electronic document storage section 1a (step S32) so as to transmit it to the terminal 2 (step S33).

Next, the terminal 2 displays the HTML electronic document for input on a screen thereof (step S34).

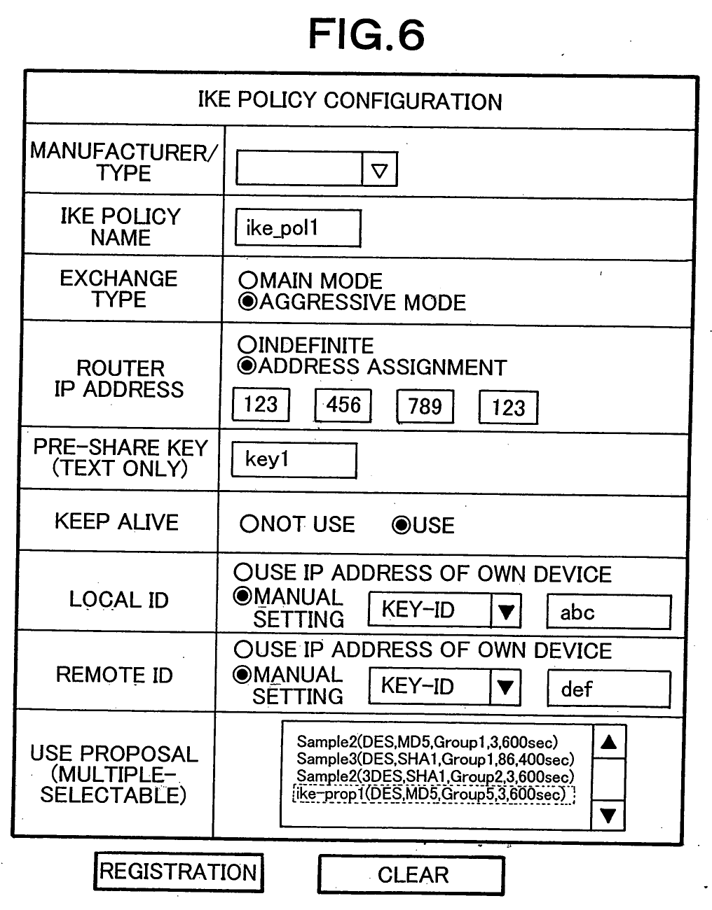

FIG. 6 shows the displayed HTML electronic document for input. The HTML electronic document for input pertains to an IKE (Internet Key Exchange) policy, which is a part of an IPsec (Internet Protocol Security Protocol) configuration. The HTML electronic document for input includes: a combo box for input of manufacturer/type of a router; a text box for input of policy name; a radio button group for input of exchange type; a radio button group and text box for input of IP address of a router; a text box for input of pre-share key; a radio button group for selecting whether or not to use “keep alive” function; a radio button group, combo box, and text box for input of local ID; a radio button group, combo box, and text box for input of remote ID; and a list box for input of use proposal. The above text boxes, combo boxes, list box, radio button groups are inserted into a form. Contents inputted into the above boxes and the like are transmitted to the http server 1b by pressing a register button. The HTML electronic document for input is common among routers of different manufacturers/types.

The terminal 2 accepts the inputs or selections through the text boxes, combo boxes, list box, and radio button groups in accordance with a user operation (step S35), and transmits the accepted contents (type identification information, configuration information, and IP address) to the http server 1b as form information (step S36).

Next, upon receiving the form information from the http server 1b, the common interface section 1c extracts the type identification information, configuration information, and IP address from the form information and supplies: the configuration information setting format search section 1e with the type identification information; the configuration information setting format application section 1f with the configuration information; and the device interface section 1g with the IP address (step S37).

Next, the configuration information setting format search section 1e searches, from the configuration information setting format database 1d, the configuration information setting format corresponding to the type identification information received from the common interface section 1c (step S38) and supplies the configuration information setting format application section 1f with the searched configuration information setting format.

Next, the configuration information setting format application section 1f applies the configuration information setting format received from the configuration information setting format search section 1e to the configuration information received from the common interface section 1c so as to supply the device interface section 1g with the configuration information that the configuration information setting format has been applied to (step S39).

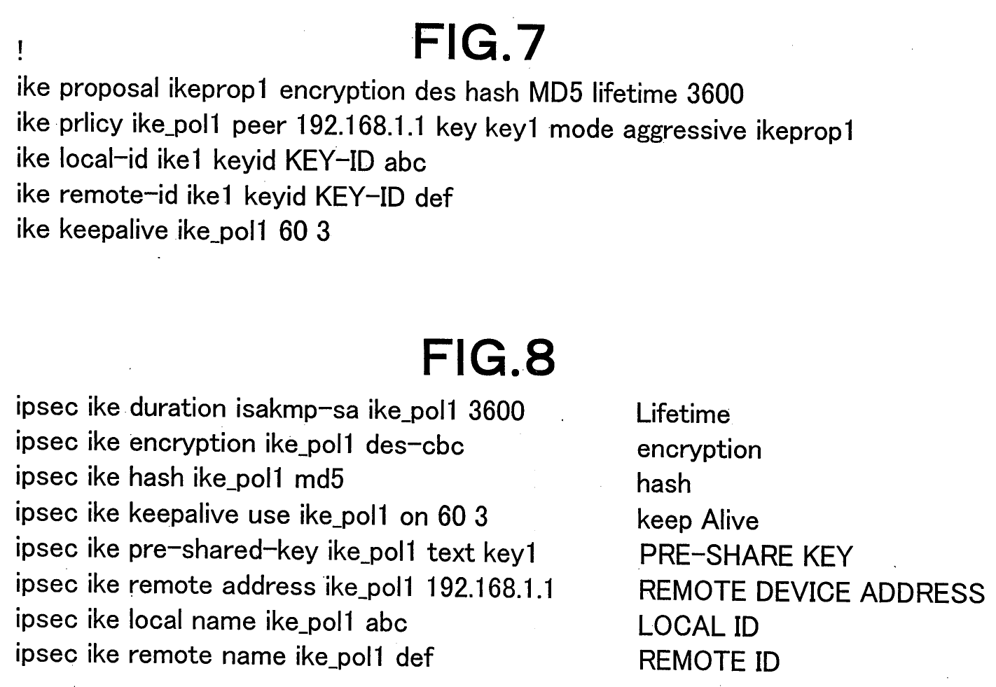

FIG. 7 shows an example of the configuration information that the configuration information setting format has been applied to. With FIGS. 6 and 7 compared with each other, IKE policy name is represented by “ike policy ike_poll” in line three of FIG. 7. Likewise, exchange type is represented by “mode aggressive” in line three, router IP address is by “peer 123.456.789.123” in line three, pre-share key is by “key key1” in line three, keep alive is by “keep alive ike_poll” in line six, local ID is by “local-id ike1 keyid KEY-ID abc” in line four, remote ID is by “remote-id ike1 keyid KEY-ID def” in line five, and use proposal is represented by “ikeprop1 encryption des hash MD5 lifetime 3600” in line two.

FIG. 8 shows another example of the configuration information that the configuration information setting format has been applied to. As can be seen by comparing FIG. 6 with FIG. 8, ike policy name is described in all the lines. Exchange type does not appear in the information of FIG. 8 since aggressive mode is default. Router IP address is represented by line six. Likewise, Pre-share key is represented by line five, keep alive is by line four, local ID is by line seven, remote ID is by line eight, and use proposal is by lines one to two.

Returning to FIG. 5, the device interface section 1g receives the configuration information that the configuration information setting format has been applied to, from the configuration information setting format application section 1f and transmits it to the router 3 (step S40).

Thereafter, the router 3 sets the received configuration information that the configuration information setting format has been applied to (step S39).

What is claimed is:

1. A configuration setting apparatus comprising:
a database which holds, for each device of different types, configuration information setting formats needed to set configurations of devices on the basis of configuration information;
first transmission means for transmitting a common electronic document among the devices of different types, the electronic document being inputted with type identification information to identify types of the devices and the configuration information needed to set configurations of the devices;
reception means for receiving, in a common format among the devices of different types, the type identification information and configuration information inputted into the electronic document;
search means for searching, from the database, a configuration information setting format that corresponds to the device type identified by the type identification information;
application means for applying the searched configuration information setting format to the received configuration information; and
second transmission means for transmitting, to a device, the configuration information that the configuration information setting format has been applied to.

2. A configuration setting apparatus according to claim 1, wherein
the electronic document is inputted with an IP address of a device in addition to the type identification information and configuration information,
the reception means receives the IP address inputted into the electronic document in addition to the type identification information and configuration information, and
the second transmission means transmits the configuration information to the device with the IP address being as a destination.

3. A configuration setting method comprising:
a step of preparing a database which holds, for each device of different types, configuration information setting formats needed to set configurations of devices on the basis of configuration information;
a first transmission step of transmitting a common electronic document among the devices of different types, the electronic document being inputted with type identification information to identify types of the devices and the configuration information needed to set configurations of the devices;
a reception step of receiving, in a common format among the devices of different types, the type identification information and configuration information inputted into the electronic document;
a search step of searching, from the database, the configuration information setting format that corresponds to the device type identified by the type identification information;
an application step of applying the searched configuration information setting format to the received configuration information; and
a second transmission step of transmitting, to a device, the configuration information that the configuration information setting format has been applied to.

4. A configuration setting method according to claim 3, wherein
the electronic document is inputted with an IP address of a device in addition to the type identification information and configuration information,
the reception step receives the IP address inputted into the electronic document in addition to the type identification information and configuration information, and
the second transmission step transmits the configuration information to the device with the IP address being as a destination.

5. A computer program product embodied on a computer-readable medium and comprising codes that, when executed, cause a computer to perform a method comprising:
a step of preparing a database which holds, for each device of different types, configuration information setting formats needed to set configurations of devices on the basis of configuration information;
a first transmission step of transmitting a common electronic document among the devices of different types, the electronic document being inputted with type identification information to identify types of the devices and the configuration information needed to set configurations of the devices;
a reception step of receiving, in a common format among the devices of different types, the type identification information and configuration information inputted into the electronic document;
a search step of searching, from the database, the configuration information setting format that corresponds to the device type identified by the type identification information;
an application step of applying the searched configuration information setting format to the received configuration information; and
a second transmission step of transmitting, to a device, the configuration information that the configuration information setting format has been applied to.

6. A computer program product according to claim 5, wherein
the electronic document is inputted with an IP address of a device in addition to the type identification information and configuration information,
the reception step receives the IP address inputted into the electronic document in addition to the type identification information and configuration information, and
the second transmission step transmits the configuration information to the device with the IP address being as a destination.
